(19) United States
(12) Patent Application Publication
(10) Pub. No.: US 2026/0248162 A1
(43) Pub. Date: Aug. 27, 2026

(54) SOUP DUMPLINGS, AND METHODS OF PRODUCING THEREOF

(71) Applicant: The XCJ Corp., Auburn, WA (US)

(72) Inventors: Josh YAU, Renton, WA (US); Zhaozhi Huang, Bellevue, WA (US); Jennifer Liao, Bellevue, WA (US); Caleb Wang, Bellevue, WA (US); Yujing Zhu, Bellevue, WA (US)

(73) Assignee: The XCJ Corp., Auburn, WA (US)

(21) Appl. No.: 19/059,919

(22) Filed: Feb. 21, 2025

(51) Int. Cl. A23L 7/109; A23J 3/14; A23L 33/125; A23L 33/16

(52) U.S. Cl. CPC A23L 7/11; A23J 3/14; A23L 33/125; A23L 33/16

(57) ABSTRACT

Provided herein dumplings that have a protein-based filling sitting in a volume of heated soup within the outer wrapper when cooked. The dumpling has a filling that incorporates a protein source, including specifically plant-based ingredients, and a gel that comprises carrageenan, locust bean gum and a suitable cation. When the dumpling is in its frozen or refrigerated form, the gel filing is a solid gel matrix. When the dumpling is cooked (e.g., by steaming or microwaving), the solid gel matrix melts to release the heated soup in which the filling sits within the wrapper. In some variations, the dumplings described herein may be referred to as soup dumplings.

### FIELD

The present disclosure relates generally to dumplings that, when cooked, have a protein filling sitting in hot soup enveloped within the dumpling wrapper.

### BACKGROUND

Xiaolongbaos (a type of “soup dumpling”) are traditionally made with a pork filling enveloped in a thin doughy wrapper. Xiaolongbaos are traditionally cooked by steaming, and as it cooks, the filling releases a “soup” in liquid form. Once cooked, the filling sits in hot, flavorful soup within the dumpling wrapper. Traditionally, this soup is made from a rich pork aspic using collagen/gelatin-rich pork skin and neck bones.

More recently, there are increasing demands for healthier and/or non-animal-based versions of food products. Thus, what is desired in the art is to produce soup dumplings that avoid the use of pork aspic but still have a comparable level of juiciness and mouthfeel as compared to traditional xiaolongbaos.

### BRIEF SUMMARY

In some aspects, provided herein is a dumpling comprising: an outer dough wrapper partially or completely surrounding a filling (e.g., protein filling) positioned at or near the middle of the wrapper. In some embodiments, the filling comprises a protein source (including, e.g., a plant-based ingredient) and a gel. The gel is made up of a certain combination of ingredients that form a solid gel matrix upon cooling (e.g., when frozen or refrigerated), and the solid gel matrix melts into liquid form upon heating (e.g., when cooking at elevated temperatures).

In one aspect, provided is a frozen or refrigerated dumpling comprising: an outer dough wrapper partially or completely surrounding a frozen or chilled filling (e.g., protein filling) positioned at or near the middle of the wrapper. In some embodiments, the filling comprises a protein source and a solid gel matrix. In some embodiments, the solid gel matrix comprises carrageenan, locust bean gum, cation, and water. In some embodiments, the solid gel matrix comprises kappa carrageenan, locust bean gum, calcium ions, and water. In some variations, the filling may further comprise other ingredients, including fat (e.g., oil), vegetables, as well as flavoring agents and seasoning.

In another aspect, provided is a cooked dumpling comprising: a cooked outer dough wrapper partially or completely surrounding a cooked filling (e.g., protein filling) positioned at or near the middle of the wrapper, sitting in a volume of soup. In some embodiments, the cooked filling comprises a protein source. In some variations, the filling may further comprise other ingredients, including fat (e.g., oil), vegetables, as well as flavoring agents and seasoning. In some embodiments, the cooked filling is formulated to mimic the taste and texture of cooked ground pork found in traditional xiaolongbaos. In some embodiments, the soup within the wrapper in which the filling sits comprises carrageenan and locust bean gum in liquid form, cation, and water. In some variations, the soup may further comprise flavoring agents and/or seasoning. In some embodiments of the cooked dumpling, the carrageenan remains in liquid form for at least about 5 mins over a temperature of at least about 35 degrees Celsius. In other embodiments of the cooked dumpling, the soup has a viscosity below about 30 millipascal-second (mpas) at a temperature at least about 35 degrees Celsius.

In some variations of the foregoing, the dumpling is vegetarian or vegan. In other variations of the foregoing, the dumpling lacks any ingredient that is an animal meat. In yet other variations, the dumpling lacks any ingredient that is an animal product.

In some variations of the foregoing, the dumplings here may be a “soup dumpling”, which refers to a dumpling with a filling (e.g., protein filling) that releases soup when cooked, such that the cooked dumpling has a cooked filling that sits in a volume of soup within the dumpling wrapper.

In other aspects, provided is a method of preparing the dumplings described herein.

### DETAILED DESCRIPTION

The following description sets forth exemplary compositions, methods, parameters and the like. It should be recognized, however, that such description is not intended as a limitation on the scope of the present disclosure but is instead provided as a description of exemplary embodiments.

In some aspects, provided is a dumpling (e.g., a soup dumpling) that incorporates a filling made up of a protein source and a gel, wrapped in an outer dough wrapper. In some embodiments, the gel comprises carrageenan, locust gum and a suitable cation that forms a solid gel matrix upon cooling (e.g., when frozen or refrigerated), and the solid gel matrix melts into liquid form upon heating (e.g., when cooking at elevated temperatures). The particular gel formulation also yields a particular product profile that mimics the mouthfeel and experience of eating traditional xiaolongbaos, in which the carrageenan remains in liquid form for a certain period of time (e.g., at least about 5 mins) after cooking, and reforms a gel when cooled. In some variations of the foregoing, the dumpling incorporates a filling that uses the gel formulation as described herein to achieve a particular product profile that mimics traditional pork-based xiaolongbaos.

The dumplings provided herein incorporate a gel made up of carrageenan, locust bean gum and a cation that bridges long chain gel molecules of the carrageenan and the locust bean gum to form a solid gel matrix upon cooling, wherein heating disrupts the bridge in long chain gel molecules bond so the gel matrix melts into liquid form to yield the soup in the cooked dumpling. This property of the gel helps to mimic the gel-liquid profile of traditional xiaolongbao, which has to achieve several key criteria.

When the dumpling is cooked (e.g., by steaming or microwaving), the solid gel matrix melts into liquid form to yield the soup in which the filling sits within the wrapper. Additionally, a large enough volume of soup has to be released from the filling, and the soup has to remain in liquid form for a period of time after steaming, so that the consumer gets the experience of biting into a dumpling that is filled with a hot, savory broth, like with traditional xiaolongbaos. If the soup returns to a solid gel form too soon after cooking, the user does not get to experience the soupy mouthfeel of the dumpling.

Selecting the appropriate combination of ingredients for the filling is critical to achieving the mouthfeel and experience described above. Surprisingly, not all commonly used gelling agents could achieve this effect. For instance, certain combinations of other ingredients did not provide enough soup to mimic the soupy mouthfeel, did not provide enough gel strength for the filling, or did not yield soup that stayed in liquid form in the time frame for consumption of the product.

The use of carrageenan in combination with locust bean gum and the appropriate cation was surprisingly observed to closely simulate gelatin from an animal source. This particular combination was unexpectedly found to gel with the appropriate gel strength and texture—such that the gel was not too brittle and had the appropriate gel strength and elasticity, making it desirable for use in the commercial manufacturing process. The locust bean gum was found to enhance the gelling property of the carrageenan. The cation caused the filling to release more soup, and also to achieve the desired gel-liquid profile within the appropriate timeframe.

The dumplings provided herein may also be prepared from frozen or refrigerated versions of the product.

The ingredients used to prepare the dumplings herein, including the ingredients making up the filling, as well as the frozen or refrigerated dumplings and the cooked dumplings are described herein further detail below.

### Dumpling Filling

### Protein Source

The dumplings incorporate a protein source. In some embodiments, the protein source comprises plant-based ingredients, pescatarian-based ingredients, or poultry-based ingredients.

In some embodiments, the protein source is non-animal-based. In certain variations, the protein source is a plant-based protein source. In one variation, the protein source comprises jackfruit. In certain variations, the protein source is soy-based. In one variation, the protein source comprises soy proteins. In another variation, the protein source comprises seaweed.

In variations where a plant-based ingredient is used, one or more additional ingredients may be incorporated in order to create the appropriate taste and texture for the filling. For instance, in some variations, the protein source comprising a plant-based ingredient may further comprise texturized vegetable protein. In one variation, the texturized vegetable protein comprises pea protein.

In some variations, the filling is formulated to mimic the taste and texture of cooked ground pork. In one variation, the protein source is non-pork-based. In some variations, the protein source comprises chicken. In yet other variations, the protein source comprises fish, seafood, or a combination thereof. In the foregoing variations, the chicken, fish and seafood may be provided in a grounded form when in used in the filling of the dumplings described herein. In one variation of the foregoing, the protein source is a kosher or halal protein source.

### Gel

In some embodiments, the gel comprises carrageenan, locust bean gum, a suitable cation, and water. In certain variations, the gel may further comprise fat (such as oil) and flavoring agents and/or seasoning. In one variation, the gel comprises carrageenan, locust bean gum, a suitable cation, water, and at least one flavoring agent(s) and/or seasoning.

In certain embodiments, the gel consists essentially of carrageenan, locust bean gum, a suitable cation, and water. As discussed above, this particular combination of ingredients (carrageenan, locust bean gum, a suitable cation, and water) is critical in creating the viscosity of the soup that is released from the filling within the wrapper upon cooking.

Carrageenan is a family of natural linear sulfated polysaccharides, extracted from red seaweed. Carrageenan is a cold set gel that forms a gel on cooling. This is in contrast to other types of gelling agents, such as heat set gels that forms gels on heating. The dumplings as described herein uses a cold set gel to achieve the product characteristics that mimic the soupy mouthfeel of traditional xiaolongbaos. Carrageenan is in solid form in the gel prior to cooking (pre-cooked product), but turns into liquid form during the cooking process—thereby mimicking the release of “soup” from the filling in traditional xiaolongbaos.

Carrageenan may be characterized based on its sulfate content. For instance, kappa carrageenan has one sulfate group per disaccharide. Iota-carrageenan has two sulfate groups per disaccharide. Lambda carrageenan has three sulfate groups per disaccharide. In some embodiments, the carrageenan comprises kappa carrageenan. In some variations, the carrageenan predominantly comprises kappa carrageenan. In some variations, at least about 75%, 80%, 85%, 90%, 95, or 99% of the carrageenan is kappa carrageenan.

Locust bean gum is a galactomannan vegetable gum, extracted from the seeds of the carob tree.

In some variations, the carrageenan and locust beam gum are less than about 5%, 4%, 3%, 2% or 1% by dry weight of the filling.

The suitable cation used in the gel described herein bridges long chain gel molecules of the carrageenan and the locust bean gum to form a solid gel matrix upon cooling, and when heated, such bridge is disrupted causing the gel matrix to melt into liquid form, thereby yielding the soup within the wrapped of the cooked dumpling. In some variations, the cation is a divalent cation. In one variation, the cation is calcium.

In some variations, the gel is between 30% and 50%, or between 35% and 45%, or about 40% by weight of the filling. In some variations, the amount of water used in the filling yields between about 2.5 g and about 5 g of soup when cooked.

In other embodiments, the amount of soup released from the filling after cooking is at least about 30%, 35%, 40%, 45%, 50%, 55%, 60%, 65%, 70%, 75%, 80%, 85%, 90% or 95% relative to the amount of solid gel matrix present in the filling before cooking.

In some embodiments, the gel further comprises fat. In some embodiments, the fat is oil. In some variations, the fat comprises coconut oil, canola oil, sunflower oil, or sesame oil, or any combination thereof.

### Other Ingredients in Filling

In some variations, in addition to the protein source and the gel, the filling further comprises at least one flavoring agent(s) and/or seasoning. Suitable flavoring agents and/or seasoning as used in the filling and/or gel may include salt, maltodextrin, vegetable extracts (e.g., extracts of leek, garlic, chive and onion), soy sauce, pepper, and mushroom powder, or any combination thereof.

In some variations, in addition to the protein source and the gel, the filling further comprises fat. In some embodiments, the fat is oil. In some variations, the fat comprises coconut oil, canola oil, sunflower oil, or sesame oil, or any combination thereof.

In other embodiments, the filling further comprises one or more vegetables. In some variations, the filling further comprises scallions and garlic. In some variation, the filling further comprises citrate (e.g., sodium citrate), or cooking wine, or a combination thereof.

In some variations, for instance to mimic the taste of traditional xiaolongbaos, the filling further comprises scallions, sodium citrate, cooking wine, and garlic. In one variation, the filling comprises jackfruit, pea protein, canola oil, methylcellulose, salt, yeast extract, vegetable juice, and citric acid. In another variation of the foregoing, the filling further comprises scallions, sodium citrate, cooking wine, and garlic. In another variation of the foregoing, the filling further comprises flavoring agent and/or seasoning, such as salt, maltodextrin, extracts of leek, garlic, chive and onion, soy sauce, pepper, and mushroom powder.

In some embodiments of the foregoing, the filling is free of other gelling agents (e.g., other than carrageenan). In some variations, the filling does not use any cold set gelling agents. In some variations, the filling does not include animal-based gelling agents. In some variations, the filling does not include pork-based gelling agents. In one variation, the filling does not include agar. In another variation, the filling does not include gelatin. In one variation, the filling has less than 10% by weight of agar. In another variation, the gelling agent used in the filling is predominantly carrageenan.

### Wrapper

The outer wrapper of the dumpling is dough-based. In some variations, the outer wrapper comprises flour, water, salt, oil, yeast and glycerin. In certain variations, the flour is wheat flour. In some variations, the flour is enriched wheat flour, which may include wheat flour, niacin, reduced iron, thiamine, mononitrate, riboflavin and folic acid. In some variations, the wrapper contains less than 2% of salt. In some variations, the oil comprises soybean oil.

In some embodiments, the outer wrapper of the dumplings is thin. In some variations, the outer wrapper has a thickness between 1 nm and 10 nm, or between 1.5 nm and 2 nm, or between 1.4 nm and 1.6 nm.

### Methods of Preparing Dumplings

In some aspects, provided is a method of preparing the dumplings described herein. In some embodiments, the method comprises: mixing water, carrageenan, locust bean gum, and a suitable cation as described herein, and optionally flavor ingredients (e.g., flavoring agents and/or seasoning), under an elevated temperature to dissolve the ingredients (including, e.g., mixing the carrageenan, locust bean gum, and cation, and optional flavor ingredients in hot water); cooling the heated mixture to form a solid gel; grinding the solid gel; mixing a protein source with one or more of vegetables, citrate and flavor ingredients (e.g., flavoring agents and/or seasoning) to form a protein mixture; mixing the ground solid gel with the protein mixture to form the filling; and wrapping a portion of the filling in an outer dough wrapper to form a dumpling.

In certain embodiments, the method further comprises freezing or refrigerating the dumpling to yield the frozen or refrigerated dumpling as described herein.

In certain embodiments, the method further comprises heating the frozen or refrigerated dumpling to yield the cooked dumpling as described herein. In some variations of the foregoing, the heating comprises steaming or microwaving. In certain variations, the dumpling is heated for a suitable time until the internal temperature reaches above about 60, 65 or 70 degrees Celsius. In certain variations, the dumpling is heated for a suitable time until the internal temperature reaches about 165 degrees Fahrenheit. In other variations, the dumpling is heated for between about 10 minutes and 15 minutes, or about 10, 11, 12, 13, 14, or 15 minutes.

In some variations, the method further comprises removing the cooked dumpling from heat and resting the cooked dumpling for about 1 to 5 minutes, or about 1 minute before eating.

### Frozen or Refrigerated Dumpling

In one aspect, provided is a frozen or refrigerated dumpling comprising an outer dough wrapper partially or completely surrounding a frozen or chilled filling positioned at or near the middle of the wrapper. In some embodiments, the filling comprises a protein source and a solid gel matrix. In some variations, the filling further comprises fat, and/or at least one flavoring agent and/or seasoning. In certain embodiments, the solid gel matrix comprises carrageenan, locust bean gum, a suitable cation, and water. In some variations, the solid gel matrix further comprises at least one flavoring agent and/or seasoning. As described herein a suitable cation is one that bridges long chain gel molecules of the carrageenan and the locust bean gum to form a solid gel matrix upon cooling, wherein heating disrupts the bridge in long chain gel molecules bond so the gel matrix melts into liquid form to yield the soup in the cooked dumpling.

In some embodiments, the solid gel matrix is between about 10% and 80%, between about 10% and 75%, between about 10% and 60%, between about 20% and 60%, between about 30% and 60%, or between about 30% and 50% by weight of the filling.

Any of the embodiments and variations of the filling, including its ingredients (e.g., the protein source, carrageenan, locust bean gum, cation, water, fat, flavoring agents and/or seasoning) as described herein may be present in the frozen or refrigerated dumpling.

In some embodiments, the dumpling is frozen. For instance, the dumpling may be stored in the freezer until use. In certain embodiments, the dumpling is stored at a temperature of less than about 0, −5, or −10 degrees Celsius; or between about 0 and −15 degrees Celsius.

### Cooked Dumpling

In another aspect, provided is a cooked dumpling comprising a cooked outer dough wrapper partially or completely surrounding a cooked filling positioned at or near the middle of the wrapper. In some embodiments, the cooked filling sits in a volume of soup (e.g., hot soup upon cooking). When the aforementioned frozen or refrigerated dumpling is heated (e.g., by cooking), the solid gel matrix melts into liquid form to yield the soup. The soup in the cooked dumpling is made up of a majority of the water in the solid gel matrix of the frozen or refrigerated dumpling (prior to heating). In some variations, at least about 30%, 35%, 40%, 45%, 50%, 60%, 70%, 80% or 90% of the water in the solid gel matrix of the dumpling prior to cooking forms the soup in the cooked dumpling. In some variations, the soup released has a temperature of at least about 35, 40, 45, 50, 55, 60, 65, 70 or 75 degrees Celsius at the end of the cooking process. In another variation, the soup reaches a temperature of about 165 degrees Fahrenheit.

In some embodiments, the cooked filling comprises the protein source. In some variations, the cooked filling further comprises fat, and/or at least one flavoring agent and/or seasoning. Any of the embodiments and variations of the filling, including its ingredients (e.g., the protein source, fat, and flavoring agents and/or seasoning) as described herein may be present in the cooked dumpling. In some variations, the cooked filling is formulated to mimic the taste and texture of cooked ground pork in traditional xiaolongbao.

In some embodiments, the soup comprises the carrageenan and locust bean gum in liquid form, the cation, and water. In some variations, the soup further comprises flavoring agents and/or seasoning.

In some embodiments of the cooked dumpling, after at least about 5 mins of cooking (e.g., reaching an internal temperature of about 165 degrees Fahrenheit), one or more of the following properties are achieved:
(1) the carrageenan remains in liquid form for at least about 5 mins over a temperature of at least about 35 degrees Celsius, or between about 35 and about 80 degrees Celsius; and
(2) the soup has a viscosity below 30 millipascal-second (mpas) at a temperature at least about 35 degrees Celsius, or between about 35 and about 80 degrees Celsius.

In some variations of the foregoing, the carrageenan remains in liquid form for at least about 5 mins over a temperature range between about 37 and about 78 degrees Celsius, and reforms a gel when the temperature range of the soup is cooled to a temperature below about 42 degrees Celsius.

In some variations of the foregoing, the soup has a viscosity between about 11.5 mpas and 30 mpas, or between about 11.7 mpas and 30 mpas. In other variations, the soup has a viscosity between about 11.5 and about 30 millipascal-second (mpas) at a temperature between about 35 and about 80 degrees Celsius. In other embodiments, the soup has a viscosity between about 11.7 and about 30 mpas at a temperature between about 38 and about 78 degrees Celsius. In certain variations, the viscosity of the soup significantly thickens between about 45 and 60 degrees Celsius, or between about 50 and 60 degrees Celsius. In some variations, once the soup is cooled below about 45 degrees Celsius or below about 42 degrees Celsius, a solid gel starts to show.

In some embodiments, the volume of soup present in the cooked dumpling is between about 2.5 g and about 5 g, or about 3 g.

In other embodiments, the gel formulation used herein achieves a soup release efficiency of at least about 30%, 35%, 40%, 45%, 50%, 55%, 60%, 65%, 70%, 75%, 80%, 85%, 90% or 95%. The “soup release efficiency” refers to the amount of soup released from the filling after cooking relative to the amount of solid gel matrix present in the filling before cooking.

The term “about” as used herein refers to the usual error range for the respective value readily known to the skilled person in this technical field. Reference to “about” a value or parameter herein includes (and describes) embodiments that are directed to that value or parameter per se. For example, “about x” includes and describes “x” per se. In some embodiments, the term “about” when used in association with a measurement, or used to modify a value, a unit, a constant, or a range of values, refers to variations of +/−10%, 5%, 2% or 1%.

Reference to “between” two values or parameters herein includes (and describes) embodiments that include those two values or parameters per se. For example, description referring to “between x and y” includes description of “x” and “y” per se. Further, it should also be understood that “between x and y” can also be expressed as “about x to y” or “about x-y”.

### Enumerated Embodiments

The following enumerated embodiments are representative of some aspects of the invention.
1. A frozen or refrigerated dumpling, comprising:
   an outer dough wrapper partially or completely surrounding a frozen or chilled filling positioned at or near the middle of the wrapper;
   wherein the filling comprises a protein source, fat, at least one flavoring agent and/or seasoning, and a solid gel matrix;
      wherein the solid gel matrix comprises carrageenan, locust bean gum, cation, and water; and
         wherein the cation bridges long chain gel molecules of the carrageenan and the locust bean gum to form the solid gel matrix.
2. The dumpling of embodiment 1, wherein the solid gel matrix is between about 30% and 50% by weight of the filling.
3. The dumpling of embodiment 1, wherein the solid gel matrix is between about 40% by weight of the filling.
4. The dumpling of embodiment 1, wherein the carrageenan and locust beam gum are less than about 5% by dry weight of the filling.
5. The dumpling of embodiment 1, wherein the carrageenan and locust beam gum are less than about 1% by dry weight of the filling.
6. The dumpling of any one of embodiments 1 to 5, wherein the cation is calcium.
7. The dumpling of any one of embodiments 1 to 6, wherein the carrageenan comprises kappa carrageenan.
8. The dumpling of any one of embodiments 1 to 7, wherein the fat is oil.
9. The dumpling of any one of embodiments 1 to 8, wherein the outer dough wrapper has a thickness between 1.4 nm and 1.6 nm.
10. The dumpling of any one of embodiments 1 to 9, wherein the outer dough wrapper comprises flour, water, salt, oil, yeast and glycerin.
11. The dumpling of any one of embodiments 1 to 10, wherein at least one flavoring agent and/or seasoning comprises salt, maltodextrin, extracts of leek, garlic, chive and onion, soy sauce, pepper, and mushroom powder.
12. The dumpling of any one of embodiments 1 to 11, wherein the protein source is a non-animal-based protein source.
13. The dumpling of any one of embodiments 1 to 11, wherein the protein source comprises a plant-based ingredient.
14. The dumpling of embodiment 13, wherein the plant-based ingredient comprises jackfruit.
15. The dumpling of embodiment 13 or 14, wherein the filling further comprises texturized vegetable protein.
16. The dumpling of embodiment 15, wherein the texturized vegetable protein comprises pea protein.
17. The dumpling of any one of embodiments 1 to 12, wherein the protein source comprises soy proteins.
18. The dumpling of any one of embodiments 1 to 17, wherein the dumpling is vegetarian or vegan.
19. The dumpling of any one of embodiments 1 to 18, wherein the dumpling lacks any ingredient that is an animal meat, or lacks any ingredient that is an animal product.
20. The dumpling of any one of embodiments 1 to 12, wherein the protein source comprises chicken, fish, or seafood, or any combination thereof.
21. The dumpling of embodiment 1, comprising: an outer dough wrapper partially or completely surrounding a frozen or chilled filling positioned at or near the middle of the wrapper, wherein the outer dough wrapper comprises flour, water, salt, oil, yeast and glycerin,
   wherein the filling comprises a plant-based ingredient, texturized vegetable protein, oil, at least one flavoring agent and/or seasoning, and a solid gel matrix,
   wherein the solid gel matrix comprises carrageenan, locust bean gum, calcium ions, and water,
   wherein the carrageenan comprises kappa carrageenan, and
   wherein the calcium ions bridge long chain gel molecules of the carrageenan and the locust bean gum to form the solid gel matrix.
22. The dumpling of embodiment 21, wherein:
   the plant-based ingredient comprises jackfruit;
   the texturized vegetable protein comprises pea protein; and
   at least one flavoring agent and/or seasoning comprises salt, maltodextrin, extracts of leek, garlic, chive and onion, soy sauce, pepper, and mushroom powder.
23. The dumpling of any one of embodiments 1 to 22, wherein the dumpling is stored at a temperature of less than about 0 degrees Celsius.
24. The dumpling of any one of embodiments 1 to 22, wherein the dumpling is stored at a temperature of less than about-10 degrees Celsius.
25. A cooked dumpling, comprising:
   a cooked outer dough wrapper partially or completely surrounding a cooked filling positioned at or near the middle of the wrapper, sitting in a volume of soup,
   wherein the cooked filling comprises a protein source, fat, and optionally at least one flavoring agent and/or seasoning; and
   wherein the soup comprises carrageenan and locust bean gum in liquid form, cation, water, and optionally at least one flavoring agents and/or seasoning; and
      wherein:
(1) the carrageenan remains in liquid form for at least about 5 mins over a temperature of at least about 35 degrees Celsius; and
(2) the soup has a viscosity below about 30 millipascal-second (mpas) at a temperature at least about 35 degrees Celsius.
26. The dumpling of embodiment 25, wherein the volume of soup is between about 2.5 g and about 5 g.
27. The dumpling of embodiment 25, wherein the volume of soup is about 3 g.
28. The dumpling of any one of embodiments 25 to 27, wherein the soup has a viscosity between about 11.5 and about 30 millipascal-second (mpas) at a temperature between about 35 and about 80 degrees Celsius.
29. The dumpling of any one of embodiments 25 to 27, wherein the soup has a viscosity between about 11.7 and about 30 mpas at a temperature between about 38 and about 78 degrees Celsius.
30. The dumpling of any one of embodiments 25 to 29, wherein the carrageenan remains in liquid form for at least about 5 mins over a temperature range between about 37 and about 78 degrees Celsius, and reforms a gel when the temperature range of the soup is below about 42 degrees Celsius.
31. The dumpling of any one of embodiments 25 to 30, wherein the carrageenan and locust beam gum are less than about 5% by dry weight of the filling.
32. The dumpling of any one of embodiments 25 to 30, wherein the carrageenan and locust beam gum are less than about 1% by dry weight of the filling.
33. The dumpling of any one of embodiments 25 to 32, wherein the cation is calcium.
34. The dumpling of any one of embodiments 25 to 33, wherein the carrageenan comprises kappa carrageenan.
35. The dumpling of any one of embodiments 25 to 34, wherein the fat is oil.
36. The dumpling of any one of embodiments 25 to 35, wherein the outer dough wrapper has a thickness between 1.4 nm and 1.6 nm.
37. The dumpling of any one of embodiments 25 to 36, wherein the outer dough wrapper comprises flour, water, salt, oil, yeast and glycerin.
38. The dumpling of any one of embodiments 25 to 37, wherein at least one flavoring agent and/or seasoning comprises salt, maltodextrin, extracts of leek, garlic, chive and onion, soy sauce, pepper, and mushroom powder.
39. The dumpling of any one of embodiments 25 to 38, wherein the cooked dumpling is prepared by heating a frozen or refrigerated dumpling with a filling comprising the protein source and a solid gel matrix, optionally fat, and optionally at least one flavoring agent and/or seasoning,
wherein the solid gel matrix comprises carrageenan, locust bean gum, cation, and water,
wherein the cation bridges long chain gel molecules of the carrageenan and the locust bean gum to form the solid gel matrix upon cooling, and wherein heating disrupts the bridge in long chain gel molecules bond so the gel matrix melts into liquid form to yield the soup, and
wherein the soup in the cooked dumpling comprises a majority of the water in the solid gel matrix of the dumpling prior to heating.
40. The dumpling of embodiment 39, wherein the solid gel matrix has a soup release efficiency of at least about 50%, wherein the soup release efficiency is the amount of soup released from the filling upon heating relative to the amount of the solid gel matrix present in the filling before heating.
41. The dumpling of any one of embodiments 25 to 41, wherein the heating comprises steaming.
42. The dumpling of any one of embodiments 25 to 41, wherein the heating comprises microwaving.
43. The dumpling of any one of embodiments 25 to 42, wherein the cooked filling has a firm texture analogous to a cooked pork meatball.
44. The dumpling of any one of embodiments 25 to 43, wherein the outer dough wrapper has a thickness between 1.4 nm and 1.6 nm.
45. The dumpling of any one of embodiments 25 to 44, wherein the outer dough wrapper comprises flour, water, salt, oil, yeast and glycerin.
46. The dumpling of any one of embodiments 25 to 45, wherein the protein source comprises a plant-based ingredient.
47. The dumpling of embodiment 46, wherein the plant-based ingredient comprises jackfruit.
48. The dumpling of embodiment 46 or 47, wherein the filling further comprises texturized vegetable protein.
49. The dumpling of embodiment 46, wherein the cooked filling comprises jackfruit, water, texturized vegetable protein, oil, and at least one flavoring agent and/or seasoning.
50. The dumpling of embodiment 48 or 49, wherein the texturized vegetable protein comprises pea protein.
51. The dumpling of embodiment 46, wherein the filling comprises jackfruit, pea protein, canola oil, methylcellulose, salt, yeast extract, vegetable juice, and citric acid.
52. The dumpling of any one of embodiments 25 to 45, wherein the protein source comprises soy proteins.
53. The dumpling of any one of embodiments 25 to 45, wherein the dumpling is vegetarian or vegan.
54. The dumpling of any one of embodiments 25 to 45, wherein the dumpling lacks any ingredient that is an animal meat, or lacks any ingredient that is an animal product.
55. The dumpling of any one of embodiments 25 to 45, wherein the protein source comprises chicken, fish, or seafood, or any combination thereof.
56. The dumpling of any one of embodiments 25 to 55, wherein the filling further comprises scallions, sodium citrate, cooking wine, and garlic.
57. The dumpling of any one of embodiments 25 to 56, wherein at least one flavoring agent and/or seasoning comprises salt, maltodextrin, extracts of leek, garlic, chive and onion, soy sauce, pepper, and mushroom powder.
58. a Cooked Dumpling, Comprising:
a cooked outer dough wrapper partially or completely surrounding a cooked filling positioned at or near the middle of the wrapper, sitting in a volume of soup,
wherein the outer dough wrapper comprises flour, water, salt, oil, yeast and glycerin, and has a thickness between 1.4 nm and 1.6 nm,
wherein the cooked filling comprises a plant-based ingredient, texturized vegetable protein, oil, and at least one flavoring agent and/or seasoning,
wherein the soup comprises carrageenan and locust bean gum in liquid form, calcium ion, water, and at least one flavoring agents and/or seasoning, and
wherein the carrageenan comprises kappa carrageenan.
59. The dumpling of embodiment 58, wherein: the plant-based ingredient comprises jackfruit; the texturized vegetable protein comprises pea protein; and at least one flavoring agent and/or seasoning comprises salt, maltodextrin, extracts of leek, garlic, chive and onion, soy sauce, pepper, and mushroom powder.
60. A method of preparing a dumpling of any one of claims 1 to 24, comprising:
mixing water, carrageenan, locust bean gum, and cation, and optionally at least one flavoring agent and/or seasoning, at an elevated temperature to form a heated mixture;
cooling the heated mixture to form a solid gel;
grinding the solid gel;
mixing a protein source with one or more of vegetables, citrate, and at least one flavoring agent and/or seasoning, to form a protein mixture;
mixing the ground solid gel with the protein mixture to form a filling; and
wrapping a portion of the filling in an outer dough wrapper to form the dumpling.
61. The method of embodiment 60, further comprising: freezing or refrigerating the dumpling to yield the frozen or refrigerated dumpling of any one of embodiments 1 to 24.
62. The method of embodiment 60 or 61, further comprising: heating the frozen or refrigerated dumpling for a suitable time to yield a cooked dumpling of any one of embodiments 25 to 59.
63. The method of claim 62, wherein the heating comprises steaming or microwaving.

### EXAMPLES

The presently disclosed subject matter will be better understood by reference to the following Examples, which are provided as exemplary of the invention, and not by way of limitation.

### Example 1: Preparation of a Plant-Based Soup Dumpling

Water, carrageenan, locust bean gum, calcium, and other flavor ingredients were mixed in hot water until fully dissolved. This heated mixture was then cooled in refrigerated temperatures to form solid gel. The resulting solid gel was ground into smaller sizes, and set aside for next steps. Jackfruit was mixed with seasonings, vegetables, citrate, and other flavor ingredients to form a meat analog mix. The ground solid gel was mixed into the meat analog mix until evenly distributed. The ratio of the meat analog to the formed solid gel matrix in the filling was about 60:40 (meat analog:gel). The result of this step is the filling material of the soup dumpling. A scoop of the filling material was placed into a sheeted dough and wrapped to form a soup dumpling.

The soup dumpling was steamed for about 11 minutes, and then removed from heat. The cooked dumplings were allowed to rest for 1 minute with the lid of the steamer on, followed by rest for an additional minute.

The steamed soup dumpling was analyzed for several characteristics. The steamed soup dumpling was observed to have a firm meatball texture, and the cooked meat analog filing was surrounded by hot soup formed from melting of the solid gel. The volume of soup in the dumpling was about 3 g. The soup was found to have a viscosity between about 11.7 to 30 millipascal-second (mpas) at a temperature between about 38 and 78 degrees Celsius. The carrageenan was observed to remain in liquid form for at least about 5 minutes over a temperature range between about 38 and 78 degrees Celsius, and reforms a gel when the temperature range of the soup is below about 42 degrees Celsius.

Overall, the soup dumpling was observed to mimic the taste and texture of traditional xiaolongbao that is made from pork filling. The soup dumpling in this example was made from an entirely plant-based formulation.

What is claimed is:

1. A cooked dumpling, comprising:
a cooked outer dough wrapper partially or completely surrounding a cooked filling positioned at or near the middle of the wrapper, sitting in a volume of soup,
wherein the cooked filling comprises a protein source; and
wherein the soup comprises carrageenan and locust bean gum in liquid form, calcium ions, and water;
wherein:
(1) the carrageenan remains in liquid form for at least about 5 mins over a temperature of at about least 35 degrees Celsius; and
(2) the soup has a viscosity below about 30 millipascal-second (mpas) at a temperature at least about 35 degrees Celsius.

2. The dumpling of claim 1, wherein the cooked filling further comprises fat.

3. The dumpling of claim 2, wherein the fat is oil.

4. The dumpling of claim 1, wherein the cooked filling further at least one flavoring agent and/or seasoning.

5. The dumpling of claim 1, wherein the volume of the soup is between about 2.5 g and about 5 g.

6. The dumpling of claim 1, wherein the carrageenan comprises kappa carrageenan.

7. The dumpling of claim 1, wherein the cooked dumpling is prepared by heating a frozen or refrigerated dumpling with a filling comprising the protein source and a solid gel matrix,
wherein the solid gel matrix comprises carrageenan, locust bean gum, calcium ions, and water.

8. The dumpling of claim 7, wherein the solid gel matrix has a soup release efficiency of at least about 35%.

9. The dumpling of claim 1, wherein the protein source is a plant-based ingredient.

10. The dumpling of claim 9, wherein the plant-based ingredient comprises jackfruit.

11. The dumpling of claim 9, wherein the filling further comprises texturized vegetable protein.

12. The dumpling of claim 1, wherein the texturized vegetable protein comprises pea protein.

13. The dumpling of claim 1, wherein the dumpling lacks any ingredient that is an animal meat, or lacks any ingredient that is an animal product.

14. A frozen or refrigerated dumpling, comprising:
an outer dough wrapper partially or completely surrounding a frozen or chilled filling positioned at or near the middle of the wrapper;
wherein the filling comprises a protein source and a solid gel matrix;
wherein the solid gel matrix comprises carrageenan, locust bean gum, cation, and water,
wherein the cation bridges long chain gel molecules of the carrageenan
and the locust bean gum to form a solid gel matrix; and
wherein the solid gel matrix is between 30% and 50% by weight of the filling.

15. The dumpling of claim 14, wherein the cation is calcium.

16. The dumpling of claim 14, wherein the protein source is a plant-based ingredient.

17. The dumpling of claim 16, wherein the plant-based ingredient comprises jackfruit.

18. The dumpling of claim 16, wherein the filling further comprises texturized vegetable protein.

19. The dumpling of claim 18, wherein the texturized vegetable protein comprises pea protein.

20. A method of preparing a dumpling of claim 14, comprising:
mixing water, carrageenan, locust bean gum, and cation, and optionally at least one flavoring agent and/or seasoning, at an elevated temperature to form a heated mixture;
cooling the heated mixture to form a solid gel;
grinding the solid gel;
mixing a protein source with one or more of vegetables, citrate, and at least one flavoring agent and/or seasoning, to form a protein mixture;
mixing the ground solid gel with the protein mixture to form a filling; and
wrapping a portion of the filling in an outer dough wrapper to form the dumpling.
